(19) United States
(12) Patent Application Publication
(10) Pub. No.: US 2021/0076644 A1
(43) Pub. Date: Mar. 18, 2021

(54) ANIMAL HEALTH, BEHAVIOR, AND INVENTORY MONITORING

(71) Applicant: FORT SUPPLY IP, LLC, Kaysville, UT (US)

(72) Inventors: Malcolm Harvey, Hyde Park, UT (US); Nephi Harvey, Kaysville, UT (US); Ian Harvey, Kaysville, UT (US)

(21) Appl. No.: 17/026,081

(22) Filed: Sep. 18, 2020

Related U.S. Application Data
(60) Provisional application No. 62/901,795, filed on Sep. 18, 2019.

(51) Int. Cl. A01K 29/00; A01K 11/00; H04L 29/08

(52) U.S. Cl. CPC A01K 29/005; H04L 67/12; A01K 11/004

(57) ABSTRACT

Systems and methods are discussed to monitor animal health and behavior. In some embodiments, a method may include reading an animal ID using a reader that reads the animal ID from a passive ear tag on the animal when the animal is within a monitoring area; storing a time stamp associated with the animal ID when the animal ID was read by the reader; determining a number of times the animal was within the monitoring area in a given period of time based on the time stamp and the animal ID; determining that the animal has likely has an illness based on the number of times the animal was within the monitoring area; and communicating the animal ID and an indication that the animal likely has an illness to a user device.

### BACKGROUND

Livestock tend to be a group of subject assets respectively manifesting social behavior, whether individually, as a social subgroup, or as a social group. For example, an animal has certain known individual or social behaviors manifesting health or illness. It can be beneficial to monitor these behaviors for improvement of efficiency and security. Livestock production is biosensitive, resource-intensive and, therefore, a margin-sensitive enterprise. Therefore, livestock producers seek to maximize production by quickly identifying individual behavior which may be deemed abnormal for a particular individual or social group. Abnormal behavior may be indicative of disease or theft which, if not mitigated by timely treatment, poses a risk of impaired well-being, or even death, both to the affected individual and to the group. Early identification of abnormal behavior may lead to timely intervention, preserving the well-being and security of individuals and the group, and increasing a producer's efficiency, competitive advantage, and profitability.

Livestock, such as cattle, are typically bred and raised in relatively open environments, where natural forces, predators, disease, injury, and theft can impair robust, optimal production and, without early intervention, may inflict significant losses. In some embodiments, livestock stewards monitor the well-being of livestock in a social group by periodic direct visual observation. However, a typical social group may have hundreds of members dispersed over a relatively large geographic region like a pasture, open range or smaller confined areas such as stock pens in feedlots, making accurate observations of individual social group members difficult, at best. Also, constituent members of a social group may become distressed and flee at the advance of, and proximity to, social group stewards (pen riders) and other human handlers. Thus, it may be difficult to ascertain the presence, the identity, and the physical state of every social group member. In many circumstances, livestock separated from the social group, for example, by wandering, injury, early onset of disease, or theft, may not be noticed in time for recovery, treatment, or processing. For some infectious diseases or other conditions, such delays may result in

extensive loss of life or substantial reductions in both the well-being of the social group and the profitability of the livestock producer. Recently, it has become desirable to trace the lineage, location, and condition of individual social group members, from birth to slaughter, with the objectives of identifying animals exposed to certain conditions and diseases, of determining the source of exposure, of improving the genetic traits, and thus profitability, of selected breeds, and of facilitating secure food production. Present systems and methods may not provide timely information about a social group and its constituent members in a manner consistent with efficient, traceable livestock production.

### SUMMARY

Embodiments of the invention include an animal monitoring system that includes a reader, a controller, a transmitter, and server. The reader, for example, may receive a plurality of animal IDs from a plurality of passive ear tags, each of the plurality of passive ear tags attached with one of a plurality of animals. The controller, for example, stores the plurality of animal IDs in a storage location along with a time stamp data associated with the time each of the plurality of animal IDs was recorded by the reader. The transmitter, for example, may be coupled with the reader. The transmitter may communicate the plurality of animal IDs and the time stamp data. The server may receive the plurality of animal IDs and the associated time stamp for each of the plurality of animal IDs; and determine a characteristic of a specific animal of the plurality of animals that is associated with a specific animal ID of the plurality of animal IDs based on the time stamp data.

In some embodiments, the server communicates the characteristic of the specific animal and the animal ID to a user device. In some embodiments, the server is a remote cloud-based server.

In some embodiments, wherein the characteristic of a specific animal comprises a characteristic selected from the list consisting of weight, health, and behavior. In some embodiments, the characteristic of a specific animal is determined based on a factor selected from the list consisting of weather, animal species, animal gender, animal sex, animal breed, animal age, and location.

In some embodiments, the server determines a period of time each animal of the plurality of animals is near the reader.

In some embodiments, the controller determines a period of time each animal of the plurality of animals is near the reader; and the transmitter communicates the period of time for each animal of the plurality of animals.

In some embodiments, the server determines the characteristic of the specific animal based on the number of times the specific animal's animal ID is read by the reader in a given period of time. In some embodiments, the server determines the characteristic of the specific animal based on an average amount of time the specific animal is near the reader over a period of time.

In some embodiments, the animal monitoring system may include a scale disposed near the reader, the scale providing weight data. The controller may receive weight data and stores weight data associated with the plurality of animal IDs and the transmitter may communicate the weight data. The characteristic of a specific animal comprises a weight of the specific animal that is determined based on the weight data and the plurality of animal IDs.

In some embodiments, a method may include reading an animal ID using a reader that reads the animal ID from a passive ear tag on the animal when the animal is within a monitoring area; storing a time stamp associated with the animal ID when the animal ID was read by the reader; determining a number of times the animal was within the monitoring area in a given period of time based on the time stamp and the animal ID; determining that the animal has likely has an illness based on the number of times the animal was within the monitoring area; and communicating the animal ID and an indication that the animal likely has an illness to a user device. In some embodiments, determining that the animal has likely has an illness is based on a factor selected from the list consisting of weather, animal species, animal gender, animal sex, animal breed, animal age, and location.

In some embodiments, a method may include reading an animal ID using a reader that reads the animal ID from a passive ear tag on the animal when the animal is within a monitoring area; storing a time stamp associated with the animal ID when the animal ID was read by the reader; determining an average amount of time the animal was within the monitoring area over a given period of time based on the time stamp and the animal ID; and determining that the animal has likely has an illness based on the average amount of time the animal was within the monitoring area; and communicating the animal ID and an indication that the animal likely has an illness to a user device. In some embodiments, determining that the animal has likely has an illness is based on a factor selected from the list consisting of weather, animal species, animal gender, animal sex, animal breed, animal age, and location.

In some embodiments, a method may include reading weight data over a period of time from a scale disposed within a monitoring area; reading a plurality of animal IDs associated with a plurality of animal IDs using a reader that reads the plurality of animal IDs from passive ear tags on the plurality of animals when the plurality of animals are on the scale; and determining the weight of at least one animal of the plurality of animals using the weight data and the plurality of animal IDs.

The various embodiments described in the summary and this document are provided not to limit or define the disclosure or the scope of the claims.

### BRIEF DESCRIPTION OF THE FIGURES

FIG. 1 is an illustration of an animal with an ear tag according to some embodiments.

FIG. 2 is an illustration of the specific area with a using an animal health behavior and inventory monitoring system according to some embodiments.

FIG. 3 is a block diagram of an animal health behavior and inventory monitoring system according to some embodiments.

FIG. 4 is a block diagram of an animal health behavior and inventory monitoring system according to some embodiments.

FIG. 5 is a photograph of an example of a fixed reading station at watering hole according to some embodiments.

FIG. 6 is an illustration of a weighing platform that can be placed at a preselected monitored location according to some embodiments.

FIG. 7 illustrates three example methods of end-to-end animal health management system using some embodiments.

FIG. 8 is an example of chart with animal ID numbers corresponding with the number of reads per day.

FIG. 9 is a presentation of data showing a tabular version of a histogram data grouping into bins the number of animals which are read according to the number of times they are read at the monitor location.

FIG. 10 is a scatter frequency plot with a number of animal IDs plotted on the Y axis and time plotted on the X axis.

FIG. 11 is a block diagram of a computational system that can be used to with or to perform some embodiments described in this document.

### DETAILED DESCRIPTION

Some embodiments include systems and methods to determine characteristics of an animal using passive RFID reader technology. Animal characteristics may include animal weight, health, hip height, color, horns, girth, specific shape, behaviors, etc. In some embodiments, animal IDs can be read from passive ear tags. This animal ID data can be time stamped and sent to a cloud server. The cloud server or local computational hardware before sending to the cloud server can determine the amount of time an animal is near a monitored location (e.g., a watering hole, a feed trough, a scale, a mineral lick, etc.), the number of times the animal approaches the monitored location, and or other factors such as, for example, weight from scale, weather data (e.g., temperature, humidity, wind speed and/or duration), insect data, the gender (male or female) of the animal, the sex (bull, steer, hermaphrodite, cow, etc.) of the animal, breed data, species data, date data, time of day data, age data, etc. In some embodiments, the health or the weight of an animal can be determined based on the collected data.

Some embodiments use a passive electronic Radio Frequency Identification (RFID) ear tag as a way to accurately identify an animal and to determine its well-being. The passive ear tag can be an ultra-high frequency (UHF) RFID ear tag or a very high frequency (VHF) RFID ear tag. The ear tag can be attached to the ear or any other part of the animal.

In some embodiments, a passive ear tag is one which responds with information when interrogated by a reader. A passive ear tag does not require an internal or onboard power supply to operate. However, active ear tags having an internal power source also may be used. Many passive RFID ear tags use low-frequency (LF) or high-frequency (HF), ultra-high frequency (UHF), very high frequency (VHF) bands, etc.

In some embodiments, the LF frequency band covers frequencies from about 30 KHz to about 300 KHz. In some embodiments, LF RFID systems for livestock operate at about 134.2 KHz, and some embodiments such as, for example, for small animals, can operate at about 125 KHz. The LF frequency band provides a short read range of about four to about twelve inches, and has slower read speed than the higher frequencies. Fixed LF readers can be relatively large—about 18 inches by about 36 inches in size, while handheld LF resemble long sticks, which are used for reaching out to a close proximity of the LF ear tag. LF RFID systems are often used with livestock tracking and comply with ISO standard 11784 and 11785. On the other hand, the HF frequency band ranges from about 3 to about 30 MHz. Most HF RFID systems operate in an ISM band at about 13.56 MHz, with read ranges between 4 inches and 40 inches. There are several HF RFID standards in place, such as the ISO 15693 standard for tracking items, and the communication master A-340 and ISO/IEC 18092 standards for Near Field Communication (NFC), a short-range technology that is commonly used for data exchange between devices. Even so, HF band data transfer rates are low, relative to UHF band data transfer rates.

In some embodiments, UHF band passive RFID ear tags can be used. The UHF frequency band covers the range from about 300 MHz to about 3 GHz. The UHF frequency band is regulated by a single global standard called the ECPglobal Gen2 (ISO 1 8000-6C) UHF (“UHF Gen2”) standard.

In some embodiments, Gen2 standard for RFID use the 860 to 960 MHz band depending on the regulations of the local governmental regulators. UHF Gen2 RFID systems in most countries operate between about 900 and about 915 MHz. The read range of passive UHF systems can be as long as about 66 feet, although shorter read ranges typically are observed. UHF RFID has a faster data transfer rate than LF or HF. In general, UHF band devices can be up to 60 times more efficient than HF devices. Longer read range and a faster read data transfer rate provide a UHF RFID ear tag with characteristics uniquely suitable and advantageous for non-invasive livestock monitoring and inventory management in terms of cost and function.

In some embodiments, an ultra-high frequency (UHF) radio band ear tag-reader (“reader”) system may be used to interrogate and read the passive UHF RFID ear tags. UHF readers can be relatively compact. A fixed UHF reader may be about 12 inches by 12 inches on a side, and about 2 inches thick, in size. A handheld UHF reader is much smaller with a pistol style hand grip and an antenna area of about 3 inches by about 3 inches. With a fixed position reader, passive UHF conveniently provides an adjustable read range of up to about 20 feet and orientation of the tag to the plane of the reader affects read range. The UHF handheld reader can read at distances up to about 10 feet. For a water hole monitoring application, a fixed UHF reader may be positioned between about 5 ft. to about 10 ft., generally vertically above, and oriented downward towards the area where and animal acquires water, minerals, or feed.

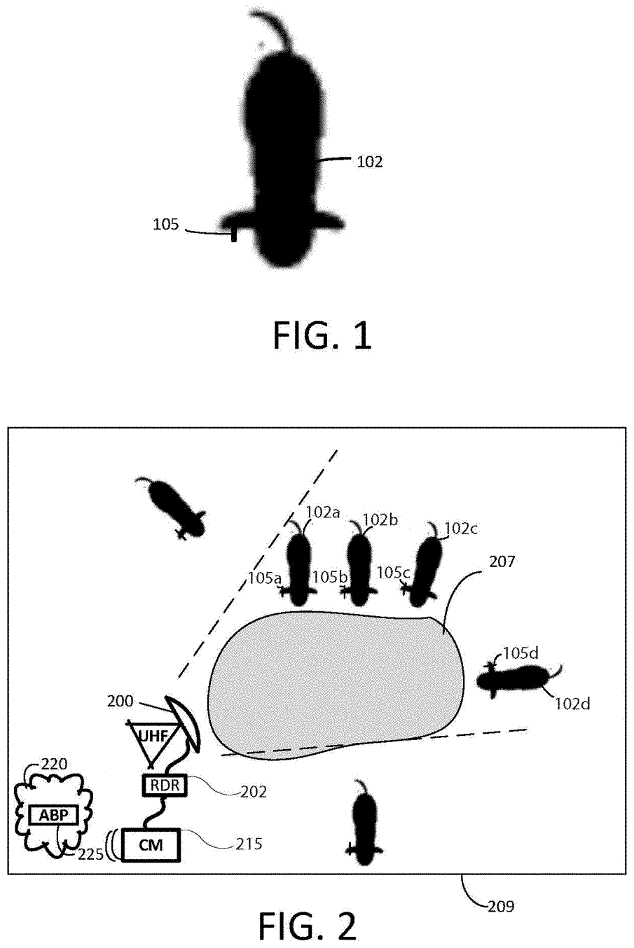

FIG. 1 is an illustration of an animal 102 with an ear tag 105. The ear tag 105 may, include a passive UHF ear tag, VHF ear tag, etc. The animal 102 may include any type of cattle such as, for example, cows, steers, sheep, hogs, horses, etc.

FIG. 2 is an illustration of a specific area 209 with a monitored location 207 with an animal health behavior and inventory monitoring system according to some embodiments. The specific area 209 may comprise a stock pen, an area near or surrounding a feeding trough with the feeding trough being the monitored location 207, an area near or surrounding a watering hole or watering trough with the watering hole or the watering trough being the monitored location 207, an area near or surrounding a salt lick with the salt like being the monitored location 207, an area near or around a gate or access point with the gate or access point being the monitored location 207, a pasture, a fenced range, etc.

Animals 102a, 102b and 102c (individually and collectively 102) can be outfitted with a respective ear tag 105a, 105b, and 105c (individually and collectively 105). Each ear tag 105 may include a unique predetermined identifier. The ear tag 105 may be read many times per second when in range of the antenna 200 (e.g., a UHF antenna). The reader 202 provides power to the antenna 200 to interrogate or activate the ear tag 105, and receives the responding signal back from ear tag 105 from the antenna 200. This process is called “reading” the ear tag 105. When the ear tag 105 comes into range of the antenna 200, ear tag reading begins (“animal present”). The onsite reader 202 creates a data stream of raw “read” data, which raw data is fed real time via serial bus to the local onsite communication master 215. The reader 202 and preselected communication master 215 systems are typically within 20 to 30 feet from the actual reading the antenna 200 which are positioned over the monitored location.

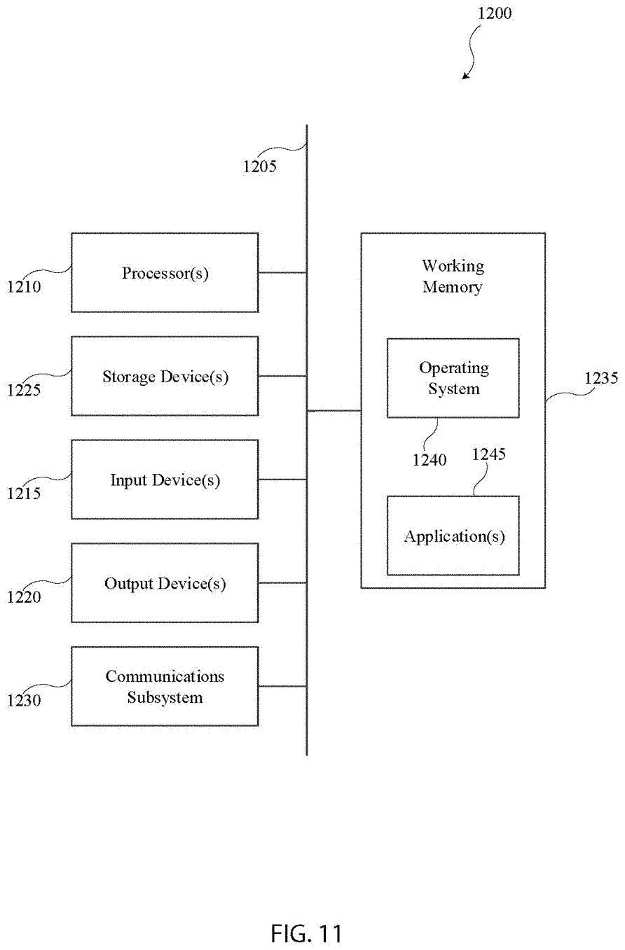

In some embodiments, the communication master 215 may include any or all the components of the computational unit 1200 shown in FIG. 11.

In some embodiments, the antenna 200 can be hard wired such as, for example, with a shielded coaxial cable to a protective environmental box containing the antenna 200 and the communication master 215.

In some embodiments, communication master 215 can receive the raw data from the reader 202 that reads the ear tag 105 and stores the read data with a time stamp for each read event in a memory buffer. In some embodiments, the communication master 215 can monitor (e.g., constantly monitor) the data in its memory buffer for an individual ear tag 105.

In some embodiments, the communication master 215 can determine if a specific ear tag 102 has or has not been read for a period of time. This period of time, for example may be defined by the user. This period of time, for example, may be within the range of about 30 to about 60 seconds. When the ear tag 105 has not been read for the period of time, the unique ear tag number along with the time stamp of when the ear tag was first read (defined as incoming data), the time stamp of the last read (defined as outgoing), and the communication master 215 identifier (“Animal Data”) can be saved in a storage location and/or transmitted to a cloud database. In some embodiments, if a specific ear tag 105 has not been read for a period of time, it may indicate that the animal 102 has moved away from monitored location 207.

The interval between recording an incoming time stamp and an outgoing time stamp is representative of a monitored event. A monitored event reading (e.g., primary filtered data) can indicate the time of day, how long the monitored event transpired and, and/or how long since the last monitored event analysis was performed by animal behavior processor 225 (e.g., how long the animal has gone without coming to the monitored location 207).

In some embodiments, the animal behavior processor 225 may include any or all the components of the computational unit 1200 shown in FIG. 11.

A change in animal behaviors in regard to an animal's 102 interaction with the monitored location 207 can be used to determine the health of the animal. Other factors may be used such as, for example, the breed, weather, time of day, location, animal age, etc. For example, an animal 102 that more or less frequently visits a salt lick (a lick event) than previously or than an average number of times may have an salt imbalance or another ailment associated with needing more or less salt. As another example, an animal 102 that more or less frequently visits a watering hole than previously or than an average number of times may have an ailment associated with under or over thirst. As another example, an animal 102 that stays near a gate for prolonged periods of time may have an ailment associated with inactivity or lethargy.

The filtered data transmitted to the animal behavior processor 225 may be stored in a database and made available for access according to, for example, user account, user location, monitor location, individual animal history and event recording. A graphical user interface may allow the user to review and manage the data in a variety of productive and adaptive views. All data, tables, charts and notifications on the animal behavior processor 225 can be available to the user through any web enabled computer and with the appropriate username and password.

Any number of animals can be monitored within the specific area 209. Open range and pasture applications may have a similar monitor hardware installation.

For example, the antenna 200 can be placed at the monitored location 207 and may be positioned and/or oriented to read each and every ear tag 105 of animals 102 within range of the antenna 200. Using passive technology, an inventory of the animals within the specific area 209 also can be developed, maintained, and/or remotely monitored.

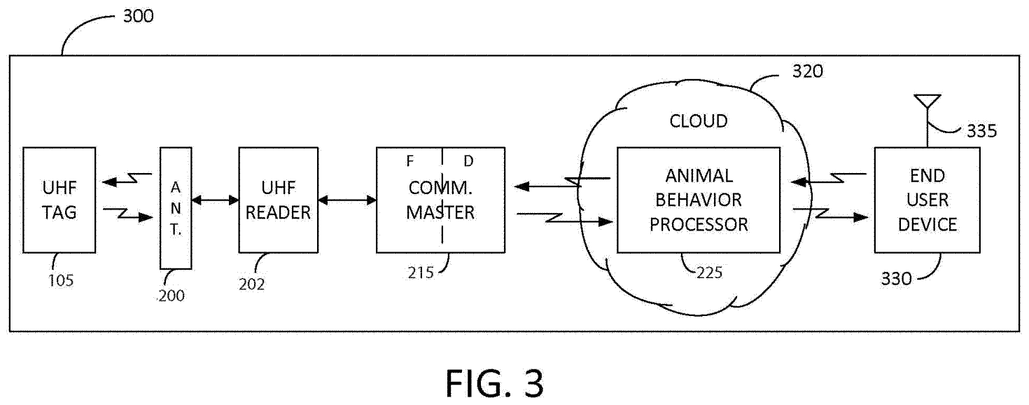

FIG. 3 is a block diagram of an animal health behavior and inventory monitoring system 300 according to some embodiments. Data may be read from ear tag 105 by antenna 200 to RFID reader 202 at an identified location can be transferred to communication master 215. In some embodiments, the reader 202 can be hard-wire linked to the local communication master 215 through a wired serial connection or connected via any wireless protocol.

The communication master 215 may be any type of data logger such as, for example, Campbell Scientific datalogger or equivalent.

In some embodiments, the communication master 215 can receive the raw information data from the reader 202, and provide the first level filtering by extracting filtered incoming or outgoing data from the raw information. The communication master 215 may then transmit the filtered incoming or outgoing data to the animal behavior processor 225. The animal behavior processor 225 can include a cloud data center hosted services that are run and accessed over an Internet infrastructure. Entry into the cloud may be, for example, by WiFi or by cellular links. Filtered data can include incoming and outgoing data. The data can be indicative of a monitored event, a lick event, or any other specific events indicating the presence of an animal at a fixed location.

In some embodiments, the communication master 215 has on-board memory to gather raw data, such as the monitored event or lick event data stream, and also has a CPU which performs the preliminary filtering of raw data stream coming from the UHF reader into primary filtered data. In some embodiments, the communication master 215 has the option of uploading the filtered data to animal behavior processor 225 in the cloud 320 through either a cellular data connection or a WiFi wireless link. The cloud 220 can include one or more cloud based servers or processors. The cloud 220, for example, may include processors, and API software. Cloud 220 might also include Fort Supply's FaST Herd™ programming, processors, and API software.

Cloud data may be accessed by the user device 330, which may be a PC or which may be a handheld PC with an RFID reader 335. The RFID reader 335, for example, may include a UHF reader antenna. One such the user device 330 may be a ruggedized field PC, tablet, or smart phone.

In some embodiments, the user device 330 may run FaST Herd™ software on the Windows® Mobile Operating System, Linux, iOS or other operating system. FaST Herd™ software is a local, point-of-use specific data collection tool. FaST Herd™ software is produced by Fort Supply Technologies, LLC, Kaysville, Utah, USA. FaST Herd™ software allows the user to associate up to 21 fields of additional data about each identified animal to the primary ID number (PID). The PID is usually a unique 15 digit number programmed into the ear tag 105. FaST Herd™ software can also by managed using any visual ID number. FaST Herd™ software can act as the central hub of data collection, EID (electronic identification), scales (weight) user comments such as key animal attributes such as, without limitation, udder score, body condition score, mouth condition, calving ease, and vaccination records.

FaST Herd™ software also has a number of output and chute-side capabilities, such as wireless linking with mobile label printers to labeling samples taken from the animal and/or wireless printing to a mobile standard (e.g., 8/5″×11″) printer for printing a spread sheet records of the animals and their recorded attributes. Up to 21 fields of user-definable data, associated with each animal, can be provided for each application (for example, chute side vaccination application versus in-field calving application, each collect different types of data). Each application can have title, and separate drop down selections for each field and separate user prompts for each field. In some embodiments, the user device 330 with an RFID reader 335. The RFID reader may include either or both an LF or UHF readers with a Bluetooth® serial connection to the user device 330. FaST Herd™ software on the user device 330 also has the ability to automatically accept a file, such as from animal behavior processor 225, which is used as a reference file. When the user (pen rider) scans the animals, the presence of the animal in the reference file is determined. If a scanned animal is in the reference file, FaST Herd™ software triggers an audible tone on the user device 330 and displays the information about the animal allowing the user to make an identifying mark on the animal for later removal, for example, when the animals might have mingled in the pen. FaST Herd™ software application can be accessed from the Cloud by FaST Herd™ cloud-based application.

In some embodiments, system 300 may be based on a FaST Herd™ cloud-based application, which can include animal behavior processor 225. In some embodiments, the animal behavior processor 225 can be the end-point cloud repository for all information collected about an animal during its life cycle. It can substitute for Meshify™ cloud elements. FaST Herd™ software can be a cloud-based herd management system using a SQL database, which can associate over one hundred fields of information with a single animal ID. An example of such information can be the records of all of the calves produced by a cow over her 15 year life span. These records can contain the full pedigree of the cow and that of the bull corresponding to each of the calves for each of the years. Also FaST Herd™ software could contain information about each calf, for example, when and where it was born, how much it weighed at birth, when it was weaned, and when it was sent to processing. In addition, collected data can include any vaccinations and treatments it received during its life cycle and any locations it frequented from birth to harvesting. Unlike other programs where the screen is filled will all of the potential fields, in FaST Herd™ software, the user is allowed to select the fields which are important for them to display and run graphical analysis. This can be important to brand inspection users, allowing optimal flexibly to the user for presentation and analysis of the data. FaST Herd Mobile™ is a mobile phone application capable of coupling with the FaST Herd™ application in the cloud, and selectively sending and receiving data.

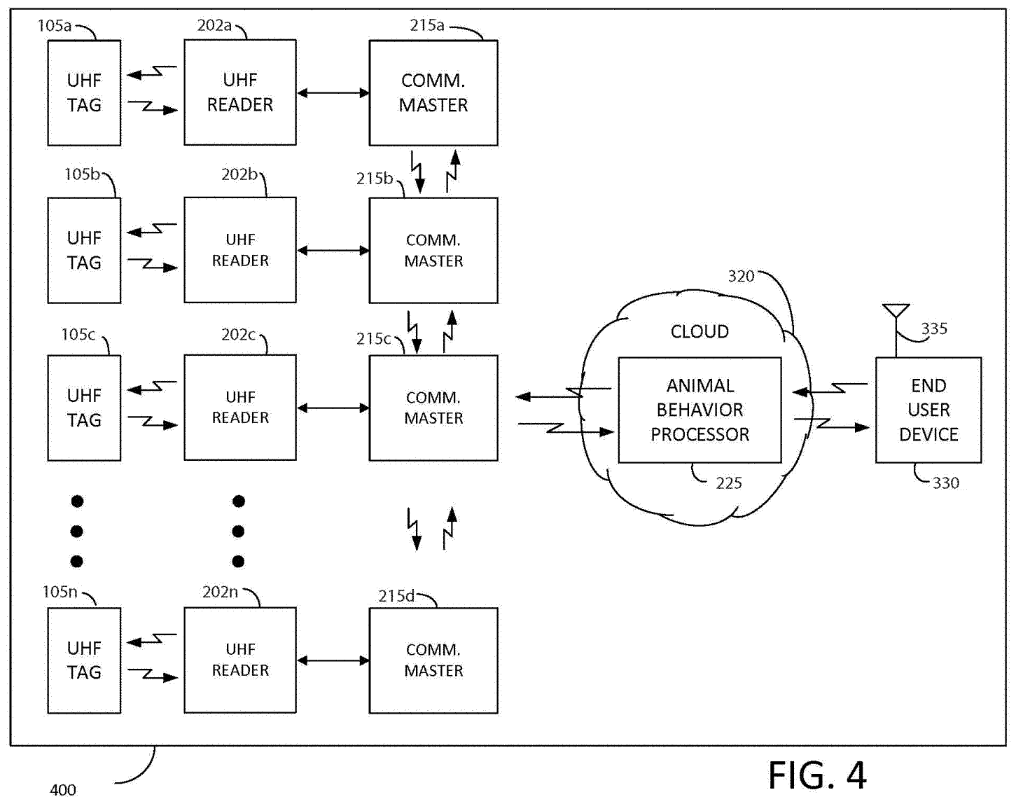

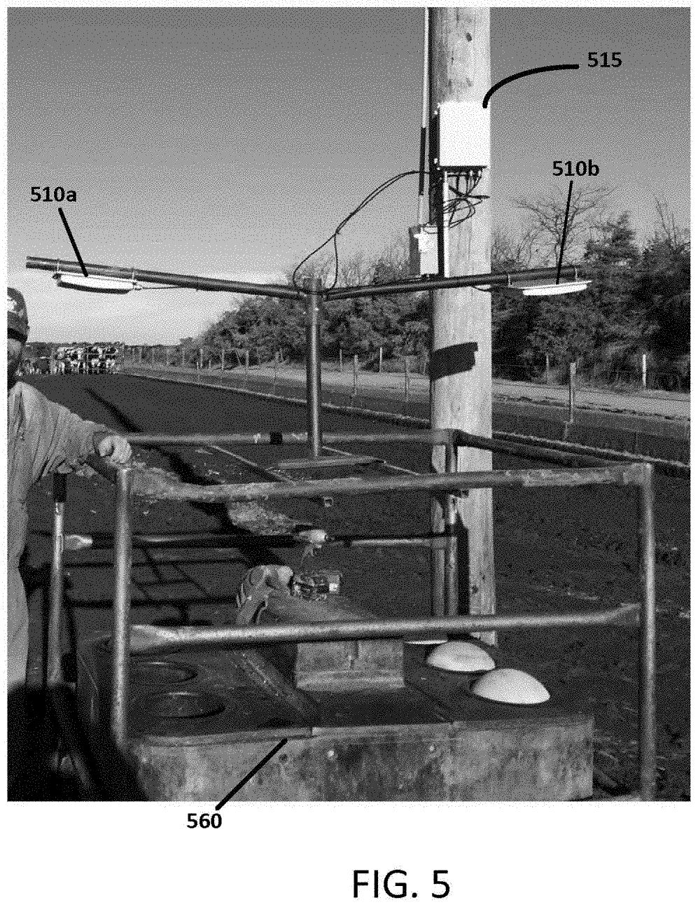

FIG. 4 is a block diagram of an animal health behavior and inventory monitoring system according to some embodiments. Animal health behavior and inventory monitoring system 400 can include a plurality of readers 202a, 202n that read ear tags from a plurality of ear tags 105a, 105n (where is representative of a selected maximum number). A plurality of readers 202a, 202n (e.g. which may include an associated antenna) may transmit data to respective multiple communication masters 215a, 215n. In one Internet of Things embodiment, communication masters 215a, 215b, 215n can pass the data to a preselected communication master 215c, which then uploads the data from all communication masters 215a, 215b, 215n to the animal behavior processor 225 in Cloud 420. This configuration is generally known as a mesh network, which may be more than 2-dimensional. The preselected communication master 215c of the mesh network may be a local central communication master 215a, 215n. Forms of multi-communication master communications other than a standard mesh configuration may be used.

Communication master 215 can communicate with an internet cloud storage location or cloud computer, which includes an animal behavior processor 225. The animal behavior processor 225, for example, can collect and process the primary filtered data of individual animals, as well as one or more local groups of individual animals, providing statistical behavior profile for a particular animal and for the one or more local groups. Collected data can be averaged, correlated, and/or analyzed on an individualized or group basis. Collected data can also be correlated with other data such as but not limited to weather, feed, animal age, time in the location, breed and location. These analytics can be provided to an end user of the animal behavior profiles and data such that current animal behavior can be characterized. In some embodiments, the raw presentation of data for an animal or group of animals can be viewed in time intervals such as 24 hours with the animal ID in the first column and each of the next columns indicating the total number of events detected at the monitored location. Automatic color coding of this tabulated data provides an easy visual indication of increasing or decreasing frequency at a monitoring location for each animal. No reads detected for an animal in a 24 hour period and excessive (multiple sigma over historical average) reads make the cell red for that date and animal. Other colored cells provide trend indication which, after collecting more data, might provide even earlier alert notification.

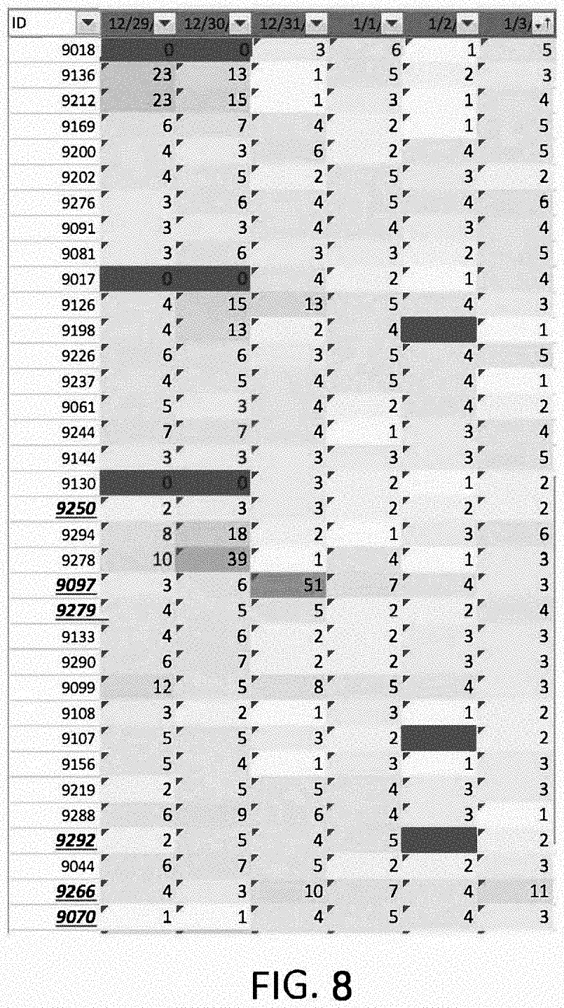

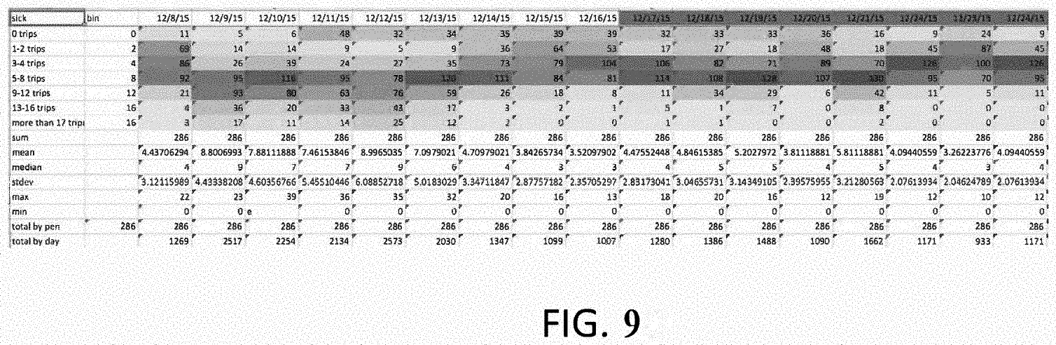

As an example, FIG. 8 is an example of chart with animal ID numbers corresponding with the number of reads per day. The first column, for example, indicates the last four unique digits of the animal's electronic identification number. The next six columns display the number of read events per 24 hour day. In this example, the data shows incoming and outgoing events to a water hole. The most recent day is on the right. The darker the green of the cell, the higher the number of read events relative to the average of the social group in this pen. Other coloring schemes are possible. Numbers which are bold highlighted in column one are animals previously treated for illness.

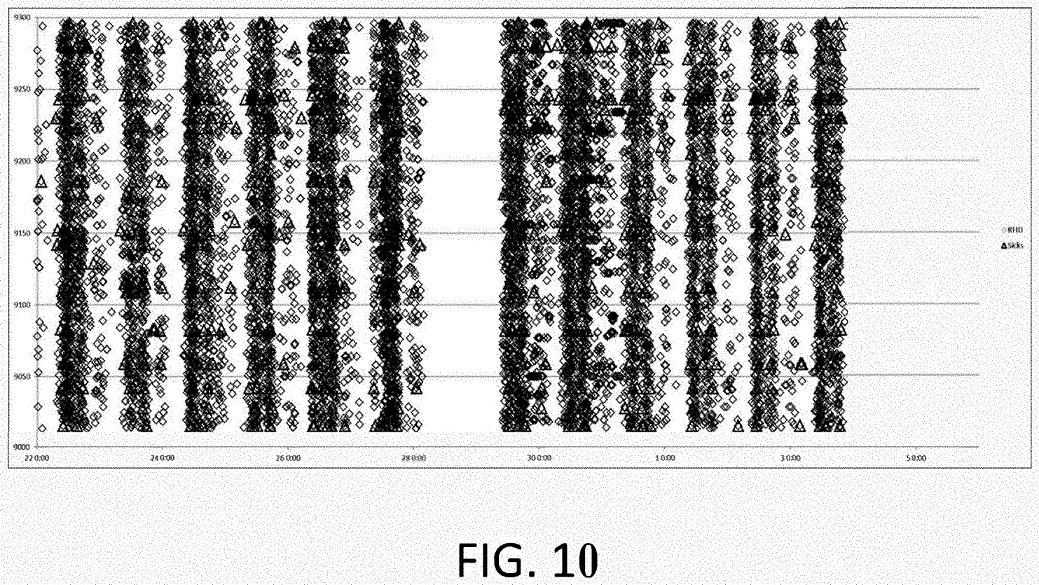

FIG. 10 is a presentation of data showing a tabular version of a histogram data grouping into bins the number of animals which are read according to the number of times they are read at the monitor location. This table also shows the change in the group average and standard deviation of read events over time, total read events each day, total animals in a pen and the individual animal maximum and minimum reads per period. All of this data contributes to detecting changes in behavior relative to external variables such as changes in environment or feed.

FIG. 10 is a scatter frequency plot with a number of animal IDs plotted on the Y axis and time plotted on the X axis. All of the filtered reads from the 215 are plotted giving a quick visual indication of the overall group watering behavior as a function of time. Each point on the chart represents a read event at the time the animal was not long read or “out.” The diamonds indicate an animal which has not been treated. The triangles indicate an animal which has been removed for treatment and returned to the pen for observation. The tight clusters of data indicate daylight hours shortly after the feed have been placed in access for the animals. The major open areas are the late night and early morning hours.

In some embodiments, the learned behavior (e.g., an adaptation of an average and a standard deviation) of an animal coming to water, visiting a mineral lick, visiting a field anti-fly applicator, or appearing at other monitored locations, which an animal voluntarily frequents, can be developed. The learned behavior of the animal can be derived through an adaptation of an average, a standard deviation, or both.

Other measures (e.g., metrics) and analytics, for example, may be used to characterize the behavior of an animal or local group, including time-series analyses.

In some embodiments, the animal behavior processor 225 can learn or be programmed to recognize the behavior of the animal, or a particular aspect of the animal's behavior, to develop a learned model of the animal's behavior, and to provide an early detection of the change in behavior of an animal. The animal behavior processor 225 may be capable of learning and providing early detection in change of behavior patterns of a selected animal, or of one or more local groups. This behavior may be analyzed by specific patterns or machine learning algorithms. The results may be reported via email, text or login to the cloud based website.

In some embodiments, a user device 330 can display data from the animal behavior processor 225 about the animals. For example, the data may be displayed on a geo map, showing at the top level a stock pen with a colored, inverse tear-drop-type “Pin” icon. If there are animals in a group which have been determined by the system to be sick the Pin icon color can be automatically changed by the animal behavior processor 225 to red. If no sick animals are in the stock pen, the Pin icon is green. Clicking on the Pin icon will provide the user with the list of animals for that pen, with the sick animals highlighted at the top of the list. Clicking on the icon for the sick animal will bring up the history of monitored events (or other specified events, including, without limitation, a lick event) for that animal over a previous selected period, for example, with a 24 hour resolution period. The user device 330 can be a web-enabled computer, coupled to animal behavior processor 225, disposed at a convenient secure, cloud based location to monitor the health and behavior of many local groups, or a feedlot, of animals.

However, the user device 330 also can be a handheld mobile PC, which can read UHF ear tags (when coupled to a handheld UHF reader) and which can communicate with animal behavior processor 225 to identify sick animals.

FIG. 5 is a side view image of an example of a fixed UHF reading station at a watering hole 560. In this example, a first antenna 510a and a second antenna 510b are disposed above the watering hole 560 such as, for example, to interact with ear tags of animals at the watering hole 560. The first antenna 510a and the second antenna 510b can be coupled by coaxial-shielded wire to communication master 515. The communication master 515 may communicate wirelessly with the cloud-based animal behavior processor

There are a number of detectable events of an animal around a water hole that may have a correlation to the health or illness of an animal. The data collected by the animal behavior processor 225, for example, may provide in and out data that indicates the number of times and the durations a given animal approaches a watering hole (or another monitored location 207). For example, an animal may have an illness if the animal does not approach the watering hole over a given period of time (e.g., 24 hours). As another example, if the animal approaches the watering hole more than an average number of times over a given period of time (e.g., 24 hours). The average number of times, for example, may be the average for the given animal, an average of a heard of animals, an average for an animal species. The average number of times, for example, may include a modified multiple standard deviation or sigma analysis. Various other indicators may be used to determine animal health such as, for example, weather, feed, lick events, animal age, time in the location, breed, and location.

As another example, the animal behavior processor 225 may determine various monitored event changes such as, for example, an average watering interval, a current watering interval, and/or a selected application of standard deviation analytic techniques thereof. As another example, the animal behavior processor 225 may determine lick event changes such as, for example, average lick interval, a current lick interval, and/or a selected application of standard deviation analytic techniques thereof. In any analysis or determination, other metrics may be used, for example, time-series analytic techniques.

Watering, for example, is an unregulated free choice behavior of animals, which is largely animal-health dependent, which can be observed remotely, and from which predetermined animal health behavior characteristics can be inferred. For a simple example, an animal that does not come to water for about 24 hours, can be identified as being ill, dead, lost, or stolen. Longer or shorter time intervals may be determined in selected situations such as time of year, breed of cattle, type of incentive for the animals to come to the reader such as a mineral lick location. Similarly, an animal that has not had a licking event within 72 hours can be seen as ill, dead, lost, or stolen. It also is possible to correlate additional data such as lick events, weather, breed, age, condition and location of the pen, time in the feed lot, change of feed, feeding schedules, and other factors to further refine the characteristics of “average behavior” for a given animal, as well as a given type of animal.

In some embodiments, the behavior of animals identified as being sick by the cloud based system can be summarized on a report, which may be automatically uploaded to one or more mobile handheld computers (e.g., user device 330) used by field person (e.g., pen riders) at a feed lot or pen. The field person, for example, may use a user device 330 to the pen where sick animals are located. During the feeding cycle when all the animals come to a fixed location (e.g., a feed bunk), the field person may scan all of the animals at the feed bunk using the user device 330. When an animal which has been identified as sick is read by the RFID reader 335 the user device 330 may provide an audible and/or visual indication that the animal is sick. The field person may use the user device 330 to confirm the identity of the sick animal. The field person may provide a visual indicator of the specific sick animal, such as, for example by paintball, chalking, or a squirt marker. Any other type of visual indicator may be used for this purpose. Marking may allow for easy visual identification of the sick animal from the group when removing the sick animal for additional disposition and treatment.

In some embodiments, animal behavior processor 225 can store monitored data in a database, and/or generate a file containing the list of sick or finished animals. This file can be automatically exported to a secure cloud location where a management program monitors the site for new files. Upon detecting such a file and based on preprogrammed settings (either in the sick or finished folder), the management program may pass the files to the appropriate a designated user device 330. The user is then notified of the download and can take the user device 330 to the pen above for identification of the animal(s) at the feed bunk. An example of such a management program can include MobiControl, which is an Enterprise Mobility Management Program, licensed from SOTI, Inc., Mississauga, Ontario, Canada. A MobiServer can operate, for example, under the control of MobiControl software, which can push data to the user device 330.

When an identified sick animal is removed from the pen, it can be taken to a vet area for treatment. At this vet area, the animal may be restrained in a head-catch or “chute.” The ear tag 105 of the sick animal can be read by the user device 330 and an indication can be sent to the animal behavior processor 225 that the sick animal is in the vat area. Often the health administrator can assess the vital signs and/or symptoms needed for a physical diagnosis of the sick animal. These vital signs and symptoms might include, but are not limited to, one or more of taking the temperature, listening to the lungs for indication of liquid or respiratory distress, observing the overall alertness and physical disposition, and documenting any presenting abnormalities. All of this information including a treatment, which may be administered to the sick animal, can be logged into animal behavior processor 225 using a user device 330. If the animal is relocated to a new pen, this new location assignment can be entered in the user device 330 and the animal information is reallocated to the new assigned location. A reader 202 and/or communication master 215 in the recovery location may give the user real-time information as to the state of recovery of the animal's health in a similar manner as the initial detection system described above.

In some embodiments, the communication master 215 can include any type of datalogger such as, for example, a Campbell Scientific datalogger or equivalent, and cloud 320. A process for operating the animal health behavior and inventory monitoring system 300 can be as follows. Animal ear tag 105 is read using reader 202, which may be a Gen2 reader. In some embodiments, reader 202 can pass a stream of serial data 312 to a Campbell Scientific datalogger local communication device. The FLY local communications node pre-processes and filters the stream of serial data 312. For example, if the animal with ear tag 105 stands in the reader 202 field for one minute and the ear tag is read 500 times in that minute, a pre-processing routine in the datalogger local communications node may collect and send only the first read and last read (animal present reads), the date and time stamp, and antenna identifier associated with those reads, indicating a monitored event. In this way, bandwidth is conserved by not sending extraneous data. The local communication node can pass the monitored event data to the local communication device via a 900 Mhz transmission frequency. The datalogger local communication device can be supported by WIFI®, ETHERNET®, and cellular capability as well as VHF and UHF mesh networking. The datalogger local communication device can be capable of selecting from among these communication modalities in order to communicate with cloud 320.

In some embodiments, the monitored event data can be transferred to the cloud 320 and/or the animal behavior processor 225 via any wireless protocol such as, for example, an IP protocol. The animal behavior processor 325 can include a backend server to receive monitored event and other data into a database, which can be a standard SQL database. Animal behavior processor 325 can extract data from the database, and perform post-processing to determine and manage the sick animal data. Data of animals identified as sick can be used to populate a file in a standard format for use by a user of the user device 330. Currently, the standard file format is a .CSV file format, but the format also may be in the XML or JSON format, or any format convenient to transmit the animal data. The file may be pushed to a server, such as a Loggernet™, where the file or messages is cued and awaits MPC or the user device 330 to come online. Many feedlots can have poor Internet service, so the user device 330 with UHF reader can be located in a local office where, as sick animal data becomes available from animal behavior processor 225, the data is pushed to the user device 330 of the pen rider corresponding to the animal. When the pen rider is dispatched, for example, in the next morning, sick animals can be identified and further processed. It also is possible for pen riders to give and receive text messages as real-time updates and communications.

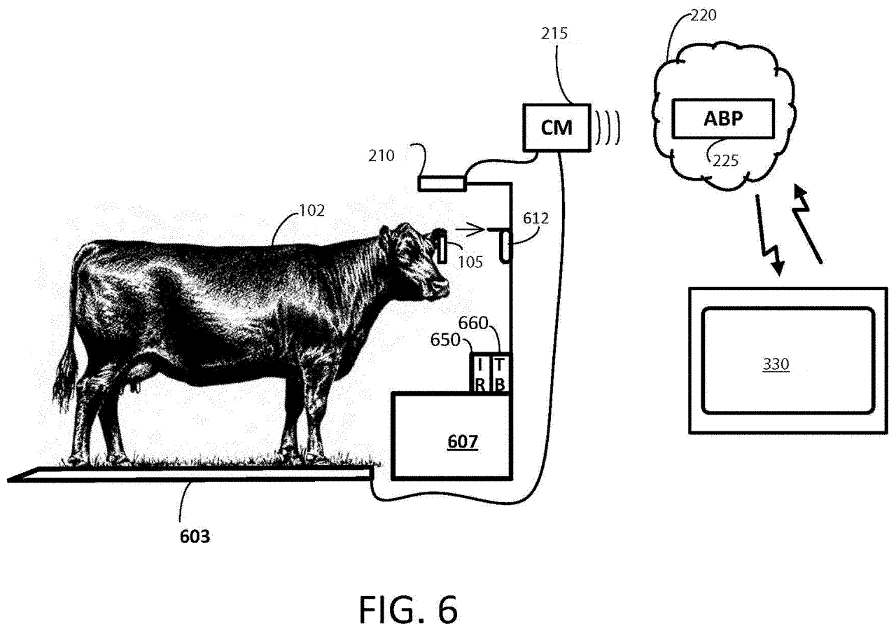

FIG. 6 is an illustration of a weighing platform 603 that can be placed at a preselected monitored location 207 such as, for example, at a watering hole, a mineral lick, or a feeding trough. Currently most feedlots feed a pen of animals as a single group for a period of time to an average target weight and send the entire pen to processing. This system does not account that some animals should have been processed earlier as they reached a point of completion, and reduced gain and feed has been wasted on their maintenance while other animals in the same group are still on a rapid rate of gain and are processed prematurely before taking advantage of their continued growth and feed conversion. Current options to separate complete-growth animals from those still growing currently include costly capital investment and infrastructure modifications to restrict animals one at a time to a combination of scale, reader, water, and feeder.

In some embodiments, an animal 102 can be selectively weighed as it waters, and have its ear tag 105 read by ear tag reader 202. The simple weighing platform 603 may weigh a selected animal 102 on four hooves, or the weighing platform may be configured to weigh the animal 102, using the front two hooves. The scale can be placed in close proximity to an open access water source, without special restriction or access to the water source. Alternatively, multiple animals may be on the scale at the same time, with nearby ear tags 105 being read by UHF reader 202. Because healthy animals typically come to water multiple times per day, they can be weighed with different animals on subsequent monitored events.

With subsequent monitored events, a calculation can be made to determine the weight of individual animals by subtracting out the weights of other animals. The accuracy of the weight of individual animals increases with each watering and weighing event as the weights of the co-weighed animals are subtracted out. In this way, accurate weighing of animal 102 can be obtained remotely over time, providing an effective production tool for removing animals which have reached their weight to be processed. Secondarily, measuring weight, rate of gain, and lack of gain or loss, provides another measure of health, productivity, and efficiency for the individual animal (and the local group) to be monitored. The weight information from weighing platform 603 can be coupled to the communication master 215 and transmitted to cloud 220 in which animal behavior processor 225 logs and processes the weight data in addition to other parameters, for example, as described above.

In this case, it may be desirable to weigh a selected animal 102 from a local group as identified by animal ear tag 105. Furthermore, a representative weight of the local group in a stock pen may wish to be determined at a particular point in time or over a predetermined interval of time. The average weight of different subgroups of animals may be determined and temporally monitored, such that the individual weights of animals can be inferred without weighing each individual animal separately. Over time, the inferred individual animal weight becomes more accurate by large numbers of samples of animal weighing. Weighing individuals from groups of animals can be important to develop an inferred “average peer” animal's weight, and the weight of a selected animal may be compared to the inferred weight of an “average peer” animal, from which the animal's general state of long-term health can be inferred. The physical development of a herd or the local group of animals overall can be determined, as a measure of when to harvest the herd or local group.

Other sensors may be used to characterize animal behavior. For example, it can be useful to add an infrared (IR) sensor 650 to monitor the temperature of an animal as it comes to a water hole. IR sensor technology, both the sensor detector and associated software, will allow accurate viewing and assessment of one or more animals in proximity to the UHF reader system. By performing temperature detection and by measuring associated changes in animal temperature over time, along with changes in behavior around a monitored location, early detection of illness can be accomplished. In addition, it could be beneficial to include such an IR sensor, for example, in a mineral lick dispenser to obtain a marker of the animal's body temperature. This reading also can be included in the primary filtered data. It also is contemplated to perform automatic marking of animals with abnormal body temperatures, for example, such as using an automated spray bottle 612, so that the animals can be identified without suffering trauma. Also, a biodevice for detecting tuberculosis (“TB Breathalyzer”) 660 can be mounted in a mineral lick dispenser, and be used to identify tuberculosis in animals based on biomarkers the animal breath. The TB Breathalyzer, for example, may include a small, battery-operated device capable of detecting tuberculosis biomarkers (e.g., one of more specific hydrocarbons) from an identified animal's breath and producing a clinical result in minutes. A positive TB result can be identified, for example, by a pen rider, who then can place a distinctive visual indicator on the animal, and who can take prompt action to remove the sick animal from its local group. In the alternative, an automatic marking system 612 can be coupled to the TB sensor 660, such that the animal is spray-marked to automatically identify the tuberculous animal upon detection.

This paint could be different from the spray-paint indicating merely “sick.” Specific animal paint identification at the monitored site could be integrated with additional restrictive infrastructure allowing only one animal at a time to access the monitored location.

Other sensors also exist for adding early detection of disease with the electronic animal identification. For example, a gas-phase sensor that takes a sample of air, when triggered by the presence of an animal, could then associate chemicals in the breath with chemicals known to be associated with specific ailment or disease. An acoustic sensor could be used to detect the breathing event. A gas-phase sensor could be used and tuned to detect a particular chemical, or the sensor may be programmed to sense a range of other detectable chemicals, which can be associated with corresponding diseases. Such sensors might include Fourier Transform InfraRed (FT-IR) spectrometers by NeoSpectra, Flintridge, Calif., USA. Similarly, it may be useful to position the IR sensor 650 or the TB sensor 660, or both, proximate to a mineral lick monitored location disposed apart from a water hole monitored location, so that the sensors can be shielded from excessive moisture.

Some possible advantages of the present system and method become apparent. There can be multiple local groups of animals in a feedlot. Using the aforementioned system, it is possible to determine behavior, health, and rate-of-gain performance of one local group relative to one or more other local groups, or relative to the animals in a feedlot. This analytic data can be useful for determining, for example, whether one stock pen has more sick animals than others, whether one stock pen has more animals that gain weight faster than others, whether animals from a particular source are more prone to sickness or rate-of-gain, whether animals of a selected breed or a selected age are more prone to sickness, whether selected times of the year or selected weather correlates with more sickness, and whether selected times of the year or selected weather correlates with more rate-of-gain. Also, it may be determined that a particular watering hole in a particular stock pen corresponds to a higher number of illnesses, indicating that the watering hole, the physical location of the stock pen, the condition of the stock pen, or a combination thereof may have pathological factors (fouled water, poor drainage, excessive manure, etc.) that make animals sick over time. This system will also allow measuring of efficacy, for example, when adding or changing feed mixtures, mineral supplements and water conditioning.

Another advantage of the aforementioned system is that it also can be useful for tracking “consigned inventory” of animals by their owners, saving significant financial cost and human resources, and providing a real time, accurate, secure and independent remote access to inventory.

The identified event can be a monitored event, in which the animal voluntarily comes to water at a fixed location, or a mineral lick event, in which the animal voluntarily comes to a mineral lick at a fixed location. The identified interval can be a watering interval or a mineral lick interval.

Another advantage of the aforementioned system is combining the foregoing functionality with services providing verification of the source and age of animals (e.g., similar to a birth certificate). Such services are also referred to Process Verified Program (“PVP”). A PVP program, for example, can provide consumers' confidence in the source of animals and provides overall traceability back to the source for faster intervention and containment in the event of a contagious animal disease outbreak. Examples of companies certified to provide age-source certification are Samson LLC in Columbus, Nebr. IMI Global in Castle Rock, Colo., and Verified Beef in Bozeman, Mont.

It can be of great interest when the current identified interval, or frequency of an animal's behavior is different from that a previous identified pattern indicating a condition of illness or loss of inventory, such as, for example, death or theft. The predetermined typical period of measurement time for a current watering interval can be 24 hours, and the predetermined time for a current mineral lick interval can be 72 hours. However, the number and length of these intervals may change according to animal needs and through observations. These periods of measurement may change as new conditions are evaluated.

In some embodiments of operations on the user device 330, a user may log in to a cloud-based account with a secure username and password. The first screen of their account displays the pens in their account on a geographically-oriented map showing at the top level, a pen with a “Pin” marker. If there are animals sick in the pen, the Pin color is red. If there are no sick animals, then the Pin is green. Clicking the pin will open the list of animals for that pen with the sick animals being highlighted at the top of the list. Clicking on the icon for a sick animal can bring up, for example, the history of water events (or lick events) for that animal on a 24 hour resolution.

Once the system is deployed, the user will rarely go into this portal as the sick animal information can be automatically passed to the field person (e.g., pen riders) for action. In the health monitor application, the Web portal interface can be used for doing top level management of and statistics of, for example, which pens are showing the most sickness, and when they are showing the most sickness and total number of animals removed to date for treatment. In the inventory ownership application, a user will be interested in the total count in each pen in which they have assigned inventory. In the rate-of-gain, or performance weight application, the user will be able to select trigger points for identifying animals based on rate-of-gain performance. A list of these animals may also be automatically sent to the pen rider for removing “finished” animals ready for processing in a manner identical to that described above for removing sick animals.

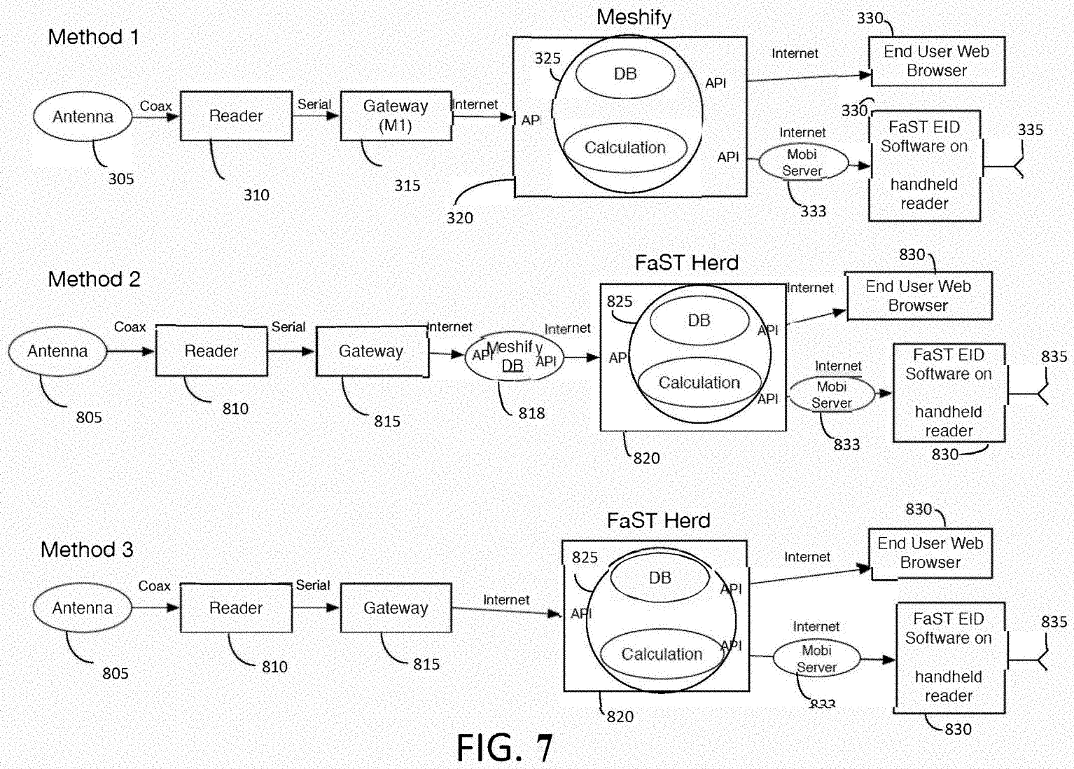

FIG. 7 illustrates three example methods of end-to-end animal health management system using some embodiments. For example, FIG. 7, Method 1, depicts system 300 of FIG. 3. Discussion regarding FIG. 3 is provided above, and can be the same for FIG. 7, Method 1. FIG. 7, Method 2, illustrates system 800, in which a gateway 815 can be replaced by a standard cloud gateway 815, with a database and APIs 818 being interposed between gateway 815 and Fort Supply Technology's FaST Herd cloud-based software. An embodiment of animal behavior processor 825 based on FaST Herd, can be included in cloud 820, and animal behavior processor 825 can communicate with end user web browser 830 or, by way of MobiControl-enabled server 833 to FaST EID software 830 coupled to handheld reader 835. Further discussion of the functionality of system 800 is similar to system 300. FIG. 7, Method 3, can be an illustration of a system 850, which includes FaST Herd cloud solution 820, used in conjunction with FaST EID software 830 coupled with handheld reader 835. In the embodiment of system 850, FaST Herd cloud solution 820, Mobi-Control (on server 833), and FaST EID software 830 are provided by Fort Supply Technology.

One set of processes for managing the behavior of an animal in a group of animals includes:

A. Collecting a plurality of temporally related data reading corresponding to an identified monitored event for an identified animal.
B. Filtering the plurality of temporally related data to produce primary filtered (incoming or outgoing or both) data for the identified animal.
C. Communicating the primary filtered data for the identified animal to an animal behavior processor.
D. Determining current identified interval or change in interval for the identified animal by the animal behavior processor.
E. Determining an average interval metric for the identified animal by the animal behavior processor.
F. Determining a standard deviation metric from the average identified interval for the animal and/or group.
G. Determining an animal health measure from the current identified interval metric, the average identified interval metric or the standard deviation metric from the average identified interval metric as may be combined and analyzed with other variables such as feed, weather, water condition, age of the animal, or a combination thereof.
H. Taking an action on the animal responsive to the animal health measure.

The computational system 1200, shown in FIG. 11 can be used to perform any of the embodiments of the invention. For example, computational system 1200 can be used to execute process 300 and 400 and the processes shown in FIG. 7 among other processes. As another example, computational system 1200 can perform any calculation, identification and/or determination described here. Computational system 1200 includes hardware elements that can be electrically coupled via a bus 1205 (or may otherwise be in communication, as appropriate). The hardware elements can include one or more processors 1210, including without limitation one or more general-purpose processors and/or one or more special-purpose processors (such as digital signal processing chips, graphics acceleration chips, and/or the like); one or more input devices 1215, which can include without limitation a mouse, a keyboard and/or the like; and one or more output devices 1220, which can include without limitation a display device, a printer and/or the like.

The computational system 1200 may further include (and/or be in communication with) one or more storage devices 1225, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 1200 might also include a communications subsystem 1230, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 1230 may permit data to be exchanged with a network (such as the network described below, to name one example), and/or any other devices described in this document. In many embodiments, the computational system 1200 will further include a working memory 1235, which can include a RAM or ROM device, as described above.

The computational system 1200 also can include software elements, shown as being currently located within the working memory 1235, including an operating system 1240 and/or other code, such as one or more application programs 1245, which may include computer programs of the invention, and/or may be designed to implement methods of the invention and/or configure systems of the invention. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 1225 described above.

In some cases, the storage medium might be incorporated within the computational system 1200 or in communication with the computational system 1200. In other embodiments, the storage medium might be separate from a computational system 1200 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 1200 and/or might take the form of source and/or installable code, which, upon compilation and/or installation on the computational system 1200 (e.g., using any of a variety of generally available compilers, installation programs, compression/decompression utilities, etc.) then takes the form of executable code.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Such quantities, for example, may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. An animal monitoring system comprising:
a reader that receives a plurality of animal IDs from a plurality of passive ear tags, each of the plurality of passive ear tags attached with one of a plurality of animals;
a controller that stores the plurality of animal IDs in a storage location along with a time stamp data associated with the time each of the plurality of animal IDs was recorded by the reader;
a transmitter coupled with the reader, the transmitter communicates the plurality of animal IDs and the time stamp data; and
a server that
receives the plurality of animal IDs and the associated time stamp for each of the plurality of animal IDs; and
determines a characteristic of a specific animal of the plurality of animals that is associated with a specific animal ID of the plurality of animal IDs based on the time stamp data.

2. The animal monitoring system according to claim 1, wherein the server communicates the characteristic of the specific animal and the animal ID to a user device.

3. The animal monitoring system according to claim 1, wherein the server is a remote cloud-based server.

4. The animal monitoring system according to claim 1, wherein the characteristic of a specific animal comprises a characteristic selected from the list consisting of weight, health, and behavior.

5. The animal monitoring system according to claim 1, wherein the characteristic of a specific animal is determined based on a factor selected from the list consisting of weather, animal species, animal gender, animal sex, animal breed, animal age, and location.

6. The animal monitoring system according to claim 1, wherein the server determines a period of time each animal of the plurality of animals is near the reader.

7. The animal monitoring system according to claim 1, wherein the controller determines a period of time each animal of the plurality of animals is near the reader; and the transmitter communicates the period of time for each animal of the plurality of animals.

8. The animal monitoring system according to claim 1, wherein the server determines the characteristic of the specific animal based on the number of times the specific animal's animal ID is read by the reader in a given period of time.

9. The animal monitoring system according to claim 1, wherein the server determines the characteristic of the specific animal based on an average amount of time the specific animal is near the reader over a period of time.

10. The animal monitoring system according to claim 1, further comprising a scale disposed near the reader, the scale providing weight data; and
wherein the controller receives weight data and stores weight data associated with the plurality of animal IDs;
wherein the transmitter communicates the weight data; and
wherein the characteristic of a specific animal comprises a weight of the specific animal that is determined based on the weight data and the plurality of animal IDs.

11. A method comprising:
reading an animal ID using a reader that reads the animal ID from a passive ear tag on the animal when the animal is within a monitoring area;
storing a time stamp associated with the animal ID when the animal ID was read by the reader;
determining a number of times the animal was within the monitoring area in a given period of time based on the time stamp and the animal ID;
determining that the animal has likely has an illness based on the number of times the animal was within the monitoring area; and
communicating the animal ID and an indication that the animal likely has an illness to a user device.

12. The method according to claim 11, wherein determining that the animal has likely has an illness is based on a factor selected from the list consisting of weather, animal species, animal gender, animal sex, animal breed, animal age, and location.

13. A method comprising:
reading an animal ID using a reader that reads the animal ID from a passive ear tag on the animal when the animal is within a monitoring area;
storing a time stamp associated with the animal ID when the animal ID was read by the reader;
determining an average amount of time the animal was within the monitoring area over a given period of time based on the time stamp and the animal ID;
determining that the animal has likely has an illness based on the average amount of time the animal was within the monitoring area; and
communicating the animal ID and an indication that the animal likely has an illness to a user device.

14. The method according to claim 13, wherein determining that the animal has likely has an illness is based on a factor selected from the list consisting of weather, animal species, animal gender, animal sex, animal breed, animal age, and location.

15. A method comprising:
reading weight data over a period of time from a scale disposed within a monitoring area;
reading a plurality of animal IDs associated with a plurality of animal IDs using a reader that reads the plurality of animal IDs from passive ear tags on the plurality of animals when the plurality of animals are on the scale; and
determining the weight of at least one animal of the plurality of animals using the weight data and the plurality of animal IDs.
